(19) United States
(12) Patent Application Publication
(10) Pub. No.: US 2013/0285500 A1
(43) Pub. Date: Oct. 31, 2013

(54) ROTOR FOR A MOTOR AND A MOTOR

(71) Applicant: Yoshikazu KINASHI, Hyogo (JP)

(72) Inventor: Yoshikazu KINASHI, Hyogo (JP)

(73) Assignee: Ichinomiya Denki Co., Ltd., Hyogo (JP)

(21) Appl. No.: 13/780,359

(22) Filed: Feb. 28, 2013

(30) Foreign Application Priority Data
Apr. 26, 2012 (JP) 2012-101650

(51) Int. Cl. H02K 1/27

(52) U.S. Cl. CPC H02K 1/276
USPC 310/156.53

(57) ABSTRACT

A first rotor and a second rotor in which first steel plates in which a plurality of first through holes into which magnets are inserted are formed circumferentially apart from each other are laminated such that the first through holes are axially continuous, a second steel plate in which second smaller through holes are formed. circumferentially apart from each other and is laminated axially at one end side, and the magnet inserted into each of the first through holes of the first and second rotor, The first and second rotor are connected to the same shaft such that the second steel plates serve as the outer sides in the axial direction and the position in the circumferential direction of each of the first through hole is shifted.

### TECHNICAL FIELD

The present invention relates to a rotor for a motor and a motor.

### BACKGROUND OF THE INVENTION

In various brushless motors, cogging torque generates due to small pulsation of magnetic attraction between a stator and a rotor depending on the rotation angle. The cogging torque causes generation of vibration and noise and also causes a reduction in control performance. Therefore, it is desirable to reduce the cogging torque as much as possible. The cogging torque generates based on the correlation between changes in the reluctance due to rotation of a rotor and a magnetic field distribution generated by magnets.

In order to reduce the cogging torque, the brushless motors are configured so that the phases of magnets are sequentially shifted along the axial direction of a shaft in some cases. Thus, a sharp change in the magnetic field associated with the rotation of a rotor is suppressed, so that the cogging torque can be suppressed. Such a method is referred to as a “skewing method”. Patent document 1 discloses a permanent magnet type motor in which the magnetic poles of rotors are skewed into two or more stages along the axial direction.

### CITATION LIST

### Patent Documents

### [Patent Document 1] Japanese Unexamined Patent Application Publication No. 2011-67090

### SUMMARY OF THE INVENTION

As disclosed in Patent Document 1, in the structure where the rotors are skewed into two or more stages, a plurality of magnets are disposed along the axial direction. The magnets which are adjacent to each other in the axial direction may sometimes repulsive force by the magnetic field generated in each magnet. There is a problem such that the magnet easily separates from the rotor due to the repulsive force. In particular, the magnets at both ends in the axial direction receive repulsive force only from the magnet which is adjacent at one side, and therefore easily separate in such a manner as to come off outward in the axial direction.

In a magnet embedded rotor in which magnets are held in an iron core, a phenomenon such that the magnets at both ends in the axial direction separate outward can be prevented by embedding the magnets in the iron core. However, when the end portion of the iron core in the axial direction contacts a steel plate, the magnetic field of the magnet is likely to be formed in the steel plate, so that the magnetic field intensity to a stator decreases. Thus, the motor efficiency decreases in some cases.

The invention has been made in view of the above-described circumstances. It is an object of the invention to provide a rotor for motor and a motor in which a magnet is difficult to separate from a rotor and a reduction in motor efficiency can be suppressed.

The following are means for solving the problems.

(1) A rotor for motor according to the invention has a first rotor and a second rotor in which first steel plates in which a plurality of first through holes into which magnets are inserted are formed apart from each other in the circumferential direction are laminated in such a manner that the first through holes are continuous in the axial direction, a second steel plate in which second through holes smaller than the first through holes are formed apart from each other in the circumferential direction and is laminated at one end side in the axial direction of each of the first rotor and the second rotor, and the magnet inserted into each of the first through holes of the first rotor and the second rotor, in which the first rotor and the second rotor are connected to the same shaft in such a manner that the second steel plates serve as the outer sides in the axial direction and the position in the circumferential direction of each of the first through holes is shifted.

In this configuration, the first rotor and the second rotor are connected in the axial direction in a state where the phases of the first through holes are shifted to one side in the circumferential direction. Therefore, the first rotor and the second rotor receive reverse torque at each position where cogging torque generates. Therefore, the cogging torque is offset, so that the rotation of the rotor can be made smooth.

Since the magnets are inserted into the first through holes, the magnets do not separate in the diameter direction by centrifugal force. Moreover, since the second steel plate is laminated at the outside of each of the first rotor and the second rotor in the axial direction, the magnets do not come off in the axial direction by repulsive force generated between two magnets which are adjacent to each other in the axial direction.

Since the second through holes smaller than the first through holes are formed apart from each other in the circumferential direction in the second steel plate, the magnetic field of the magnets are difficult to be formed toward the second steel plate, so that a reduction in the magnetic field intensity toward a stator can be suppressed.

(2) The positions in the circumferential direction of the first through holes of the first rotor and the second rotor may be shifted only by 360/(Order of cogging torque×2)[°].

Herein, the “order of cogging torque” is the least common multiple of the number of slots of the stator and the number of poles of the rotor in a motor.

(3) A third through hole may be provided in each of the first steel plates and the second steel plates at a position where the phase is shifted to one side in the circumferential direction relative to any one of the first through holes only by 360/(Order of cogging torque×4) [°] in such a manner that all the third through holes communicate with each other.

In this configuration, by merely connecting the first rotor and the second rotor, and then bringing the third through holes into agreement with each other, the first through holes of the first rotor and the second rotor can be disposed in such a manner as to be shifted only by 360/(Order of cogging torque×2) [°] in the circumferential direction.

(4) At least one projection which presses the magnet may be provided in each of the first through holes in such a manner as to be projected inward in a diameter direction from a periphery of each of the first through holes

The magnets are pressed inward in the diameter direction by the projections, and adhere by magnetic force to the edge at the inner side in the diameter direction which define the first through holes. In this configuration, the magnets do not press the edge outward in the diameter direction which defines the first through holes by centrifugal force. More specifically, the rotor is prevented from being deformed or damaged due to load applied to a portion with a low rigidity around the first through holes.

(5) The invention can also be regarded as a motor having the rotor for motor described in any one of (1) to (4) above and a stator having a plurality of electromagnets facing the rotor for motor in the diameter direction.

### Effects of the Invention

According to the rotor for motor and the motor according to the invention, the magnets are prevented from separating from the rotor and a reduction in the motor efficiency can be suppressed.

### BRIEF DESCRIPTION OF THE DRAWINGS

FIG. 1 is a schematic view illustrating the configuration of a brushless motor 10 according to an embodiment of the invention.

FIG. 2 is a plan view of a stator 13.

FIG. 3 is a perspective view of a rotor 11.

FIGS. 4(A) shows perspective views in which the rotor 11 is disassembled in the direction of an axis L1. FIG. 4(B) is a plan view of a first steel plate 21 constituting a first rotor 22 and a second rotor 23. FIG. 4(C) is a plan view of a second plate 24.

FIG. 5(A) is a cross sectional view in which the rotor 11 is cut along the axis L1. FIG. 5(B) is a view illustrating the arrangement of first through holes 25 in the first rotor 22 and the second rotor 23. FIGS. 5(C) and (D) are views illustrating the positional relationship of the first through holes 25 and second through holes 27 in the first steel plate 21 and the second steel plate 24 which are adjacent to each other.

FIGS. 6(A) are plan views of the first steel plate 21 according to a modification 3 of the embodiment. FIG. 6(B) is a plan view in which the circumference of the first through hole 25 of a laminate of the first steel plates 21 according to the modification 3 of the embodiment, and illustrates the state where a magnet 15 is inserted into the first through hole 25. FIG. 6(C) is a plan view in which the circumference of the first through hole 25 of the laminate of the first steel plates 21 according to a modification 4 of the embodiment, and illustrates the state where a magnet 15 is inserted into the first through hole 25.

### DESCRIPTION OF THE PREFERRED EMBODIMENTS

Hereinafter, the invention is described in detail based on a preferable embodiment with reference to the drawings. This embodiment is merely an example of the invention and can be altered as appropriate in the range where the gist of the invention is not changed.

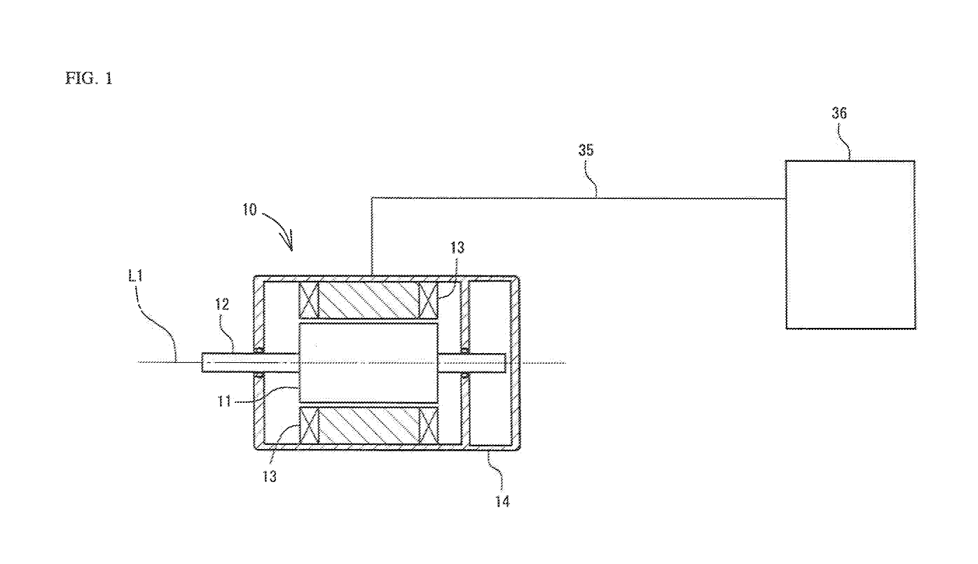

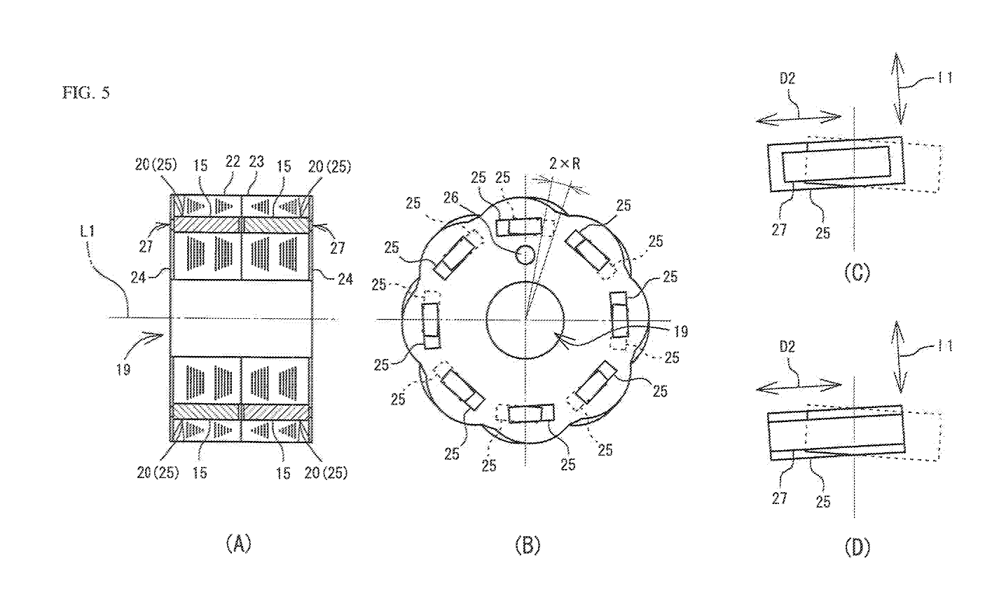

A brushless motor 10 illustrated in FIG. 1 has a rotor 11 (an example of the rotor for motor of the invention), a shaft 12, a stator 13, a housing 14, and the like. The housing 14 accommodates the rotor 11, the shaft 12, and the stator 13 therein. The rotor 11 has a substantially columnar shape and has a plurality of magnets 15 (FIG. 5) along the circumferential direction. The rotor 11 is externally fitted to the shaft 12 to be integrated therewith. The shaft 12 is supported by the housing 14 and is integrally rotatable with the rotor 11.

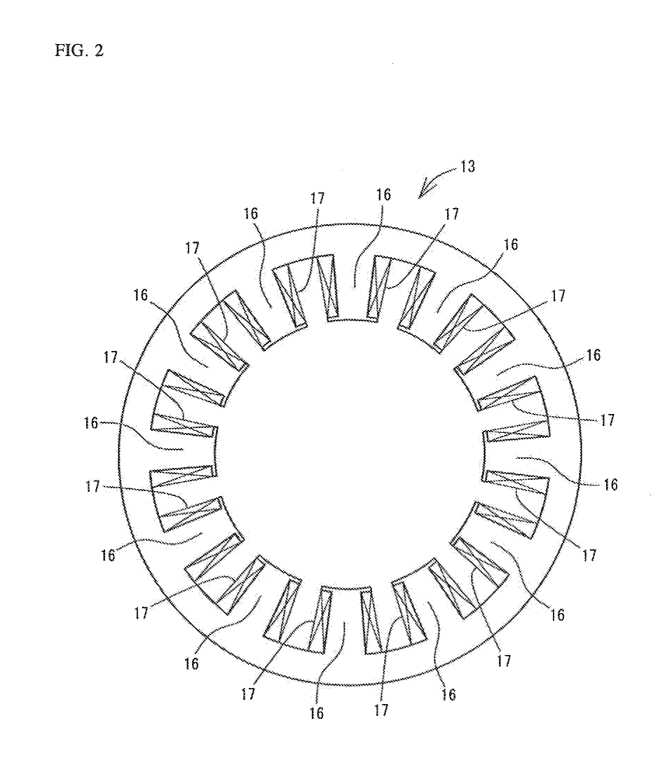

The stator 13 is fixed to the inside of the housing 14, and is disposed in such a manner as to cover the periphery of the rotor 11. The stator 13 has a plurality of teeth 16 (FIG. 2). Each of the plurality of teeth 16 faces the rotor 11 in the diameter direction.

Each of the teeth 16 is wound by a coil 17 (FIG. 2). The coil 17 is electrically connected to a control circuit 36 by a cable 35. A magnetic field is generated in the coil 17 by a current from the control circuit 36. Then, torque which rotates the rotor 11 generates by attractive force and repulsive force acting between the coil 17 in which the magnetic field is generated and the magnets 15 mounted on the rotor 11.

Although not illustrated in FIG. 1, the brushless motor 10 may have a resolver for the control circuit 36 to recognize the number of rotations and the rotation angle of the rotor 11 and the shaft 12 and the like.

### [Stator 13]

The stator 13 illustrated in FIG. 2 has almost a cylindrical shape. The stator 13 has 12 teeth 16 projected to the center of the cylinder. The 12 teeth 16 are arranged at equal intervals in the circumferential direction. More specifically, each teeth 16 is disposed at a position where the phase is shifted by 360/12=30 [°] in the circumferential direction.

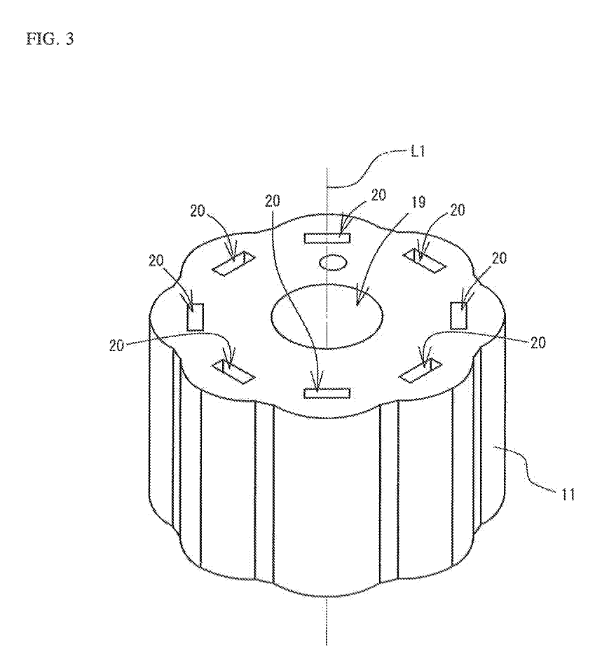

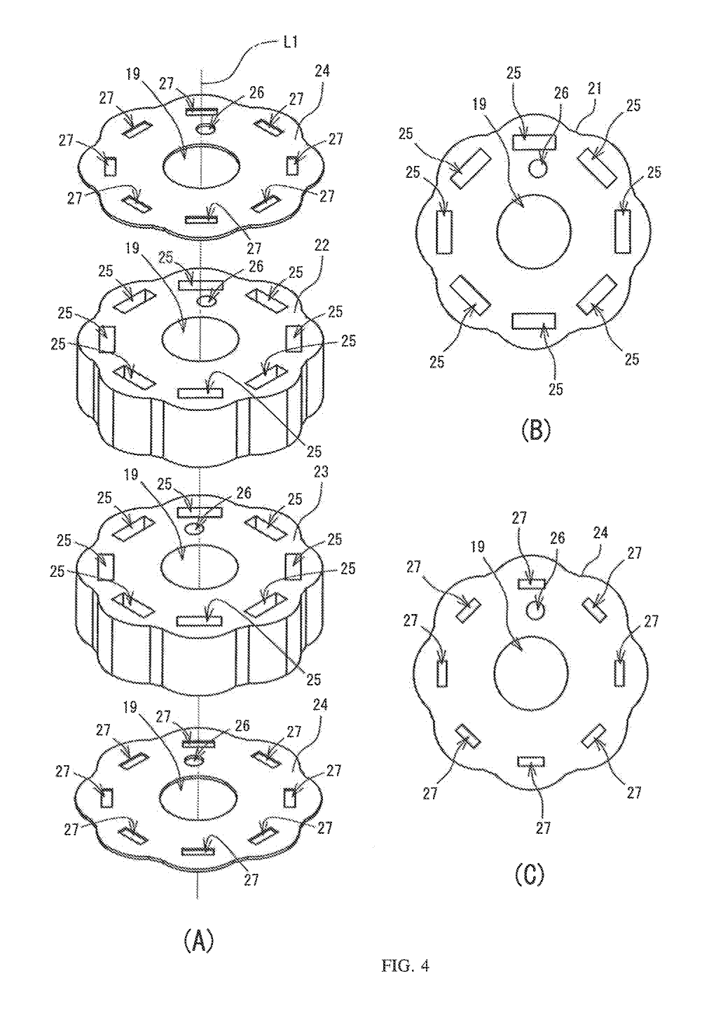

Each teeth 16 is wound by the coil 17. The coil 17 is electrically connected to the control circuit 36, and generates a magnetic field based on a current supplied from the control circuit 36. The stator 13 is one in which a plurality of non-oriented electrical steel plates typified by iron or the like, for example, are laminated in the direction of an axis L1 (refer to FIG. 1, Direction perpendicular to the paper of FIG. 5), and fixed by crimping or the like.

[Rotor 11] The rotor 11 illustrated in FIG. 3 has a substantially columnar shape. A shaft hole 19 into which the shaft 12 is inserted is opened at the center of the rotor 11. At eight places along the circumferential direction around the shaft hole 19, internal spaces 20 where the magnets 15 are held are formed. In FIGS. 3 and 4, the magnets 15 are omitted. The outer circumferential surface of the rotor 11 slightly protrudes outward in the diameter direction at positions corresponding to the internal spaces 20 to form a corrugated shape. This is because the gap between the teeth 16 and the rotor 11 is set to a suitable value according to the rotation angle of the rotor 11.

As illustrated in FIGS. 4(A), the rotor 11 has the first rotor 22 and the second rotor 23 which are configured by laminating a predetermined number of the plurality of first steel plates 21 (FIG. 4(B)) and two second steel plates 24 (FIGS. 4(A) and 4(C)). The first rotor 22 and the second rotor 23 are connected to each other along the direction of the axis L1 (an example of the axial direction of the invention), and each of the second steel plates 24 is laminated at both outsides in the direction of the axis L1 of the first connected rotor 22 and the second rotor 23.

The first steel plate 21 illustrated in FIG. 4(B) is a non-oriented electrical steel plate typified by iron or the like. The first through holes 25 which form the internal spaces 20 are opened at eight places along the circumferential direction around the shaft hole 19. The first through holes 25 have a rectangular shape as viewed in plan. More specifically, the first through holes 25 are opened at the positions where the phases are shifted in the circumferential direction by 360/8=45 [°]. A third through hole 26 which is a round hole as viewed in plan is opened at a position which is located inside in the diameter direction relative to the first through hole 25 and where the phase is shifted only by an angle R in the circumferential direction from the first through hole 25 serving as a reference.

The phase shift of the first through hole 25 and the third through hole 26 is defined based on the center of the third through hole 26 and the center of the first through hole 25. Herein, the center of the third through hole 26 is the center of the circle as viewed in plan and the center of the first through hole 25 is the intersection of the diagonal lines of the rectangle as viewed in plan. More specifically, the phase of the center of the third through hole 26 is shifted only by the angle R in the circumferential direction relative to the center of the first through hole 25 serving as a reference. In an example of FIG. 4(B), the third through hole 26 is opened around the position where the phase is shifted clockwise only by the angle R based on the center of the first through hole 25 located at the position of 12:00. The angle R is an angle given by the following expression.

R=360/(Order of cogging torque×4)[°] [Expression of Angle R]

Herein, the order of the cogging torque is the least common multiple of the number of slots of the stator 13 and the number of poles of the rotor 11. In this embodiment, since 12 teeth 16 are arranged in the circumferential direction, the number of slots of the stator 13 is 12. Since eight magnets 15 are arranged in the circumferential direction, the number of poles of the rotor 11 is 8. More specifically, the order of the cogging torque in this embodiment is 24,and R=3.75 [°] is established.

Into each of the internal spaces 20 formed by the first through holes 25 of the first rotor 22, the magnet 15 having a rod shape (FIG. 5(A)) is inserted.

The length of the magnet 15 in the direction of the axis L1 is the same as or slightly shorter than the length of the first rotor 22. The cross-sectional shape orthogonal to the axis L1 of the magnet 15 has a rectangular shape similar to the shape of the first through hole 25 and is slightly smaller than the first through hole 25. More specifically, the magnet 15 stays with slight room in the internal space 20 formed by the first through hole 25.

The magnets 15 inserted into the first through holes 25 which are adjacent to each other in the circumferential direction have mutually opposite polarities in the diameter direction. More specifically, in the magnet 15 adjacent to the magnet 15 whose S pole is directed outward in the diameter direction, the N pole is directed outward in the diameter direction. Similarly, the magnets 15 are inserted also into the first through holes 25 of the second rotor 23. More specifically, 16 magnets 15 in total are held in the internal spaces 20 of the first rotor 22 and the second rotor 23. After the magnets 15 are inserted into the first rotor 22 and the second rotor 23, the magnets 15 may be fixed with an adhesive or the like.

The second steel plates 24 illustrated in FIGS. 4(A) and 4(C) have almost the same shape as that of the first steel plate 21. Second through holes 27 smaller than the first through holes 25 are opened in the second steel plates 24 at positions corresponding to the first through holes 25 of the first steel plates 21. The opening of the shaft hole 19 and the third through holes 26 and the arrangement thereof are the same as those of the first steel plate 21. The second through holes 27 are set to the shape and the size in such a manner that the magnets 15 cannot pass through the holes. In detail, in the projection from the direction of the axis L1, at least one part of the magnet 15 may be located outside the outline of the second through hole 27.

Although the first rotor 22 and the second rotor 23 have the same shape and configuration, the first rotor 22 and the second rotor 23 are connected in a state where the back and front surfaces are inverted to each other. For example, the first rotor 22 in FIGS. 4(A) is obtained by laminating the first steel plate 21 with the surface illustrated in FIG. 4(B) as the upper surface. On the other hand, the second rotor 23 in FIGS. 4(A) is obtained by laminating the first steel plate 21 with a surface opposite to the surface illustrated in FIG. 4(B) as the upper surface. By inverting the back and front surfaces, the positions of the third through holes 26 to the first through hole 25 serving as a reference are shifted in the opposite direction in the circumferential direction.

The second steel plates 24 are also laminated on the first rotor 22 and the second rotor 23 in a state where the back and front surfaces are inverted to each other. More specifically, in FIGS. 4(A), although the surface illustrated in FIG. 4(C) is the upper surface in the second steel plate 24 laminated on the first rotor 22, the surface illustrated in FIG. 4(C) is the lower surface in the second steel plate 24 laminated on the second rotor 23.

The first rotor 22, the second rotor 23, and the two second steel plates 24 are connected in the direction of the axis L1, whereby the rotor 11 is manufactured. The details are described below. First, a predetermined number of the first steel plates 21 and one second steel plate 24 are laminated, and then fixed by crimping or the like, whereby a laminate containing the first rotor 22 and the second steel plate 24 is manufactured. In this case, the first rotor 22 and the second steel plate 24 are fixed in a state where the shaft holes 19 and the third through holes 26 are in agreement with each other. Separately, another one set of the same laminate is manufactured to be used as a laminate of the second rotor 23 and the second steel plates 24. In this embodiment, 22 first steel plates 21 are laminated for each of the first rotor 22 and the second rotor 23. In this stage, the magnet 15 is inserted into each of the internal spaces 20, and then fixed.

The two laminates are connected in such a manner that the first rotor 22 and the second rotor 23 are adjacent to each other, and then integrally fixed by crimping or the like, whereby the rotor 11 is manufactured. In this case, the first rotor 22 and the second rotor 23 are fixed in a state where the shaft holes 19 and the third through holes 26 are in agreement with each other. When laminating and fixing the first steel plates 21 and the second steel plates 24, a shaft for positioning or the like may be temporarily inserted into the shaft holes 19 and the third through holes 26.

As illustrated in FIG. 5(A), the rotor 11 is configured so that the first rotor 22 and the second rotor 23 are connected along the axis L1 and one second steel plate 24 is laminated at both outsides with the first rotor 22 and the second rotor 23 sandwiched therebetween. The magnet 15 is inserted into each of the first through holes 25 in the first rotor 22 and each of the first through holes 25 in the second rotor 23. More specifically, two magnets 15 are disposed along the direction of the axis L1. Each of the first rotor 22 and the second rotor 23 contain 22 first steel plates 21. More specifically, when the two second steel plates 24 are added, the rotor 11 is constituted by laminating 46 steel plates in total in the direction of the axis L1.

As described above, the first rotor 22 and the second rotor 23 are connected to each other in such a manner that the third through holes 26 are in agreement with each other in a state where the back and front surfaces are inverted. Therefore, the phases of the first through holes 25 of the first rotor 22 are shifted to one side in the circumferential direction only by R=3.75 [°] relative to the position of the communicated third through holes 26. Similarly, the phases of the first through holes 25 of the second rotor 23 are shifted to the other side in the circumferential direction only by R=3.75 [°] relative to the position of the communicated third through holes 26.

In FIG. 5(B), the first through holes 25 of the first rotor 22 are illustrated by the solid line and the first through holes 25 of the second rotor 23 are illustrated by the dashed lines. In an example of FIG. 5(B), the phases of the first through holes 25 of the first rotor 22 are shifted counterclockwise to the position of the communicated third through holes 26 and the phases of the first through holes 25 of the second rotor 23 are shifted clockwise to the position of the communicated third through holes 26. More specifically, the phases of the first through holes 25 of the second rotor 23 are shifted clockwise only by 2>R=7.5 [°] relative to the first through holes 25 of the first rotor 22. The phase shift is relative and it is a matter of course that the phase shift directions may be opposite to each other between the first rotor 22 and the second rotor 23.

The first rotor 22 and the second steel plate 24 are laminated in such a manner that the second through holes 27 of the second steel plate 24 are overlapped with the communicated first through holes 25 of the first rotor 22. As described above, the magnets 15 are held in the internal spaces 20 formed by the first through holes 25 of the first rotor 22. The second through holes 27 are smaller than the first through holes 25. In detail, the second through holes 27 have a size in which the magnets 15 cannot pass through the second through holes 27. More specifically, the magnets 15 are prevented from coming off outward in the axial direction by the second steel plate 24.

The relationship between the second rotor 23 and the second steel plate 24 laminated on the second rotor 23 is also the same as the relationship described above. More specifically, the second through holes 27 of the second steel plate 24 are overlapped with the communicated first through holes 25 of the second rotor 23. As described above, the magnets 15 are held in the internal spaces 20 formed by the first through holes 25 of the second rotor 23. The magnets 15 are prevented from coming off outward in the axial direction by the second steel plate 24.

The size of the second through holes 27 can be changed as appropriate insofar as the magnets 15 cannot pass through the second through holes 27 as described above.

As an example, as illustrated in FIG. 5(C), the opening length of the second through hole 27 may be shorter than the opening length of the first through hole in both a diameter direction D1 and a tangential direction D2. Or, as illustrated in FIG. 5(D), the opening length of the second through hole 27 may be shorter than the opening length of the first through hole 25 only in the diameter direction D1.

In the brushless motor 10 according to this embodiment, the first rotor 22 and the second rotor 23 are connected in the direction of the axis L1 in a state where the phases of the first through holes 25 are shifted only by 2×R=7.5 [ ] to one side in the circumferential direction in the rotor 11. In the brushless motor 10 according to this embodiment, the first rotor 22 and the second rotor 23 receive opposite torque at each position where cogging torque generates. Therefore, the cogging torque is offset, so that the rotation of the rotor 11 can be made smooth.

Moreover, since the magnets 15 are held in the internal spaces formed by the first through holes 25, the magnets 15 do not separate in the diameter direction by centrifugal force. Moreover, since the second steel plate 24 is laminated at the outside of each of the first rotor and the second rotor in the axial direction, the magnets 15 do not come off outward in the axial direction from the internal spaces 20 by repulsive force generated between two magnets which are adjacent to each other in the axial direction.

The second through holes 27 smaller than the first through holes 25 are formed at positions corresponding to the first through holes 25 in the second steel plate. Therefore, a gap is formed in the passage of the magnetic field from the magnets 15 to the second steel plate 24. More specifically, the magnetic field of the magnets 15 is difficult to be formed toward the second steel plate, so that a reduction in the magnetic field intensity toward the stator 13 can be suppressed. Thus, the properties of the brushless motor 10 can be improved.

In this embodiment, since the rotor 11 is manufactured only from the first steel plates 21, the second steel plates 24, and the magnets 15, the manufacturing of the rotor 11 is facilitated. In particular, the second steel plate 24 is the same as the first steel plate 21 except that the second through holes 27 are formed in place of the first through holes 25. Accordingly, in manufacturing processes, when continuously punching out the first steel plates 21 and the second steel plates 24 by a die from a metal plate, the same die can be used for the first steel plates 21 and the second steel plates 24. Until the stage of forming the first through holes 25 or the second through holes 27, the first steel plates 21 and the second steel plates 24 can be manufactured in a common process.

The rotor 11 can be also manufactured by, in the process of laminating the first steel plates 21 and the second steel plates 24, and then fixing them, bringing the third through holes 26 into agreement with each other in a state where the back and front surfaces of a half number of the first steel plates 21 and the second steel plates 24 are inverted to each other, and then fixing all of the first steel plates 21 and second steel plates 24. Thus, in this embodiment, positioning in the circumferential direction is easily performed due to the fact that the third through hole 26 is opened in each of the first steel plates 21 and the second steel plates 24.

### [Modification 1]

In the brushless motor 10 according to the embodiment described above, the first rotor 22 and the second rotor 23 hold eight magnets 15 along the circumferential direction and the stator 13 has 12 teeth along the circumferential direction. More specifically, the brushless motor 10 is a motor having 8 poles and 12 slots. However, the invention is not limited to the number of poles and the number of slots described above. More specifically, the same effects as those of the embodiment described above can be demonstrated irrespective of the number of poles and the number of slots of the brushless motor 10 insofar as the phases of the first through holes 25 are shifted only by the angle of 2×R to one side in the circumferential direction between the first rotor 22 and the second rotor 23.

For example, when the brushless motor 10 has characteristics of 6 poles and 9 slots, the order of cogging torque is 18. More specifically, R=360/(Order of cogging torque×4)=5 [°] is given by the expression of the angle R shown above. In this case, the phases of the first through holes 25 of the first rotor 22 and the phases of the first through holes 25 of the second rotor 23 are shifted in the circumferential direction only by 2×R=10 [°].

### [Modification 2]

In the embodiment described above, although the first rotor 22 and the second rotor 23 are connected in the direction of the axis L1, a larger number of rotors having the same configuration as that of the first rotor 22 and the second rotor 23 (hereinafter referred to as a partial rotor) may be connected in the direction of the axis L1, whereby the rotor 11 is constituted. In this case, in each partial rotor, the phases of the first through holes are sequentially shifted in the circumferential direction to one side in the direction of the axis L1. Thus, the generation of cogging torque can be further reduced.

### [Modification 3]

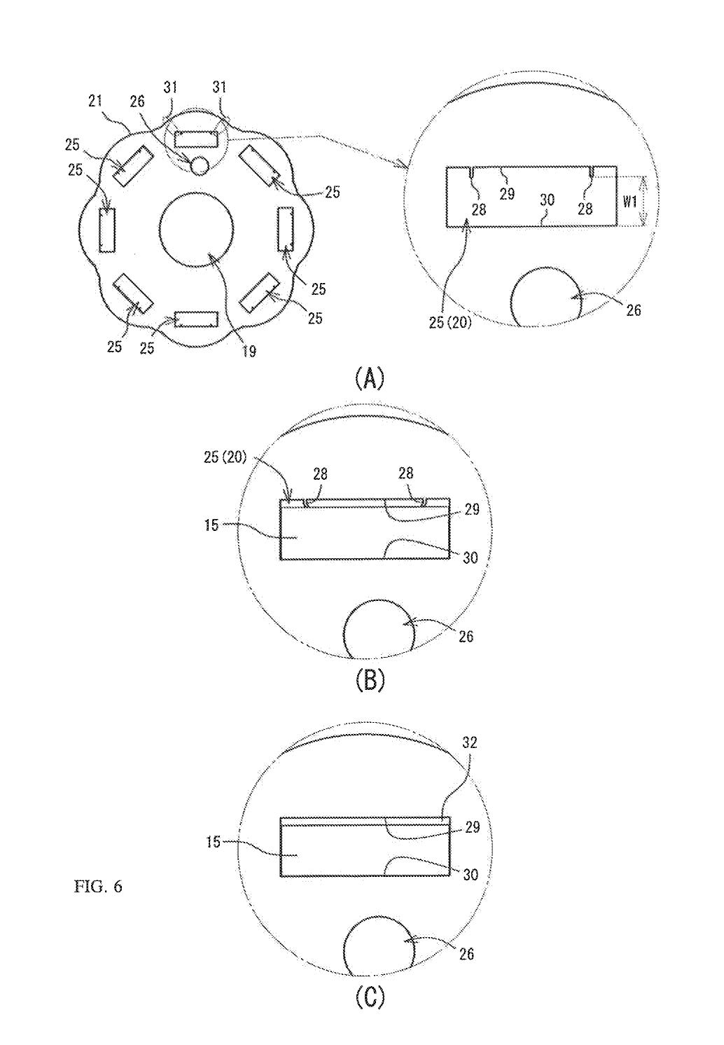

As illustrated in FIGS. 6(A), in the embodiment described above, projections 28 may be projected from the periphery of the first through hole 25 in the first steel plate 21. The projections 28 are projected inward in the diameter direction from an edge 29 corresponding to the side at the outer side of the two sides facing each other in the diameter direction in the first through holes 25 having a rectangular shape. In other words, the first through holes 25 are opened in a rectangular shape in which portions corresponding to the projections 28 are chipped.

Although the projections 28 are provided at two portions along the edge 29, a larger number of projections 28 may be provided. The projection 28 may be provided only in some of the first steel plates 21 constituting the first rotor 22 and the second rotor 23. A distance W1 from the tip of the projection 28 to an edge 30 facing the edge 29 is slightly shorter than the size in the diameter direction of the magnets 15 inserted into the first through holes 25. More specifically, the magnets 15 are press-fitted into the first through holes 25. In this case, as illustrated in FIG. 6(B), the projections 28 in each of the first steel plates 21 are pressed by the magnets 15 to be inwardly bent. The magnets 15 are pressed inward in the diameter direction, i.e., edge 30 side, by the projections 28. As a result, the magnets 15 are maintained in a state where the magnets 15 abut to the edge 30 by the pressing force and the magnetic force caused by the projections 28.

During the rotation of the rotor 11, centrifugal force acts on the magnets 15. Supposing that the magnets 15 adhere to the edge 29 by magnetic force, the magnets 15 press the edge 29 outward in the diameter direction by the centrifugal force. Thus, a high load is applied to narrow portions 31 (FIGS. 6(A)) around the first through holes 25. Since the narrow portions 31 are formed in such a manner as to have a narrow width at the request of a reduction in size of the rotor 11, the rigidity is low. The narrow portions 31 are deformed or damaged by the load in some cases. On the other hand, in this modification, since the magnets 15 adhere to the edge 30 by magnetic force, the magnets 15 do not directly press the edge 29. Since only the centrifugal force based on the mass of the portions between the narrow portions 31 of the first steel plate 21 acts as a load to the narrow portions 31, the possibility of deformation and damage of the narrow portions 31 is reduced.

### [Modification 4]

As a configuration which demonstrates the same effects as those of the modification 3 described above, an adhesive layer 32 may be formed on the surface at the side of the edge 29 which defines the internal space 20 before inserting the magnet 15. The adhesive layer 32 is formed by applying an adhesive to the surface at the side of the edge 29 with a given thickness, and then curing the adhesive. When inserting the magnet 15, a space corresponding to the thickness of the adhesive layer 32 is maintained between the edge 29 and the magnet 15. Thus, the magnet 15 is close to the edge 30 rather than the edge 29, and is maintained in a state where the magnet 15 adheres to the edge 30 by magnetic force.

### DESCRIPTION OF REFERENCE NUMERALS

11 Rotor (Rotor for motor)
13 Stator
15 Magnet
21 First steel plate
22 First rotor
23 Second rotor
24 Second steel plate
25 First through hole
26 Third through hole
27 Second through hole
28 Projection

1. A rotor for a motor, comprising:
a first rotor and a second rotor, each one of the first rotor and second rotor having a plurality of first steel plates that are laminated and in which a plurality of first through holes are formed apart from each other in a circumferential direction in such a manner that the first through holes are continuous in an axial direction;
a second steel plate in which second through holes smaller than the first through holes and formed apart from each other in the circumferential direction laminated at one end side in the axial direction of said each one of the first rotor and second rotor; and
magnets inserted into each of the first through holes of the first rotor and the second rotor; and
wherein the first rotor the second rotor, and each one of the second steel plates are connected to in such a manner as to share a same axis, wherein each one of the second steel plates serves as an outer side of the rotor in the axial direction, and wherein the position in the circumferential direction of each of the first through holes is shifted.

2. The rotor for the motor according to claim 1, wherein positions in the circumferential direction of the first through holes of the first rotor and the second rotor are shifted by 360° divided by twice an order of cogging torque.

3. The rotor for motor according to claim 2, wherein a third through hole is provided in each of the first steel plates and the second steel plates at a position where phase is shifted to one side in the circumferential direction relative to any one of the first through holes by 360° divided by four-times an order of cogging torque in such a manner that all the third through holes communicate with each other.

4. The rotor of the motor according to claim 1, wherein for each one first through hole at least one projection presses the magnet provided said one first through hole in such a manner as to be projected inward in a diameter direction from a periphery of said each one of the first through holes.

5. A motor, comprising:
the rotor for the motor according to claim 1; and
a stator having a plurality of electromagnets facing the rotor for the motor in a diameter direction.

6. A rotor for a motor, comprising:
a first rotor and a second rotor connected together and having a shared axis, each one of the first rotor and second rotor comprising a plurality of first steel plates, each one first plate among the plurality having a plurality of first through holes formed apart from each other in a circumferential direction into which magnets are inserted, the plurality of first steel plates being laminated in such a manner that the plurality of first through holes are continuous in an axial direction;
a second steel plate for each one of the first rotor and second rotor being laminated at one end side in the axial direction of said each one of the first rotor and second rotor, respectively, wherein each second steel plate has a plurality of second through holes formed apart from each other in the circumferential direction, each one second through hole being smaller than a corresponding first through hole; and
the magnets inserted into each of the first through holes of the first rotor and the second rotor; and
wherein the first rotor, the second rotor, and each one of the second steel plates are connected to share said common axis, wherein each one of the second steel plates serves as an outer side of the rotor in the axial direction, and wherein for each one of the first rotor and second rotor the position of each one of the first through holes is offset in the circumferential direction relative to second through holes of the second steel plate at said outer side of said one of the first rotor and second rotor.
